(19) United States
(12) Patent Application Publication
(10) Pub. No.: US 2025/0108837 A1
(43) Pub. Date: Apr. 3, 2025

(54) METHODS AND SYSTEMS FOR PERSONALIZED ADAS INTERVENTION

(71) Applicant: Harman Becker Automotive Systems GmbH, Karlsbad-Ittersbach (DE)

(72) Inventors: Robert Franz Klaus Kempf, Eggolsheim (DE); Bernhard Pirkl, Beilstein (DE); Eric Theisinger, Otterbach (DE)

(21) Appl. No.: 18/725,060

(22) PCT Filed: Dec. 20, 2022
(86) PCT No.: PCT/IB2022/062559

§ 371 Date: Jun. 27, 2024

Related U.S. Application Data
(60) Provisional application No. 63/266,043, filed on Dec. 27, 2021.

(51) Int. Cl. B60W 60/00; B60W 10/04; B60W 10/18; B60W 10/20; B60W 40/08; B60W 40/09; G06V 20/59

(52) U.S. Cl. CPC B60W 60/00253; B60W 10/04; B60W 10/18; B60W 10/20; B60W 40/09; G06V 20/597; B60W 2040/0827; B60W 2420/403; B60W 2540/22; B60W 2540/229; B60W 2540/30

(57) ABSTRACT

Examples are disclosed of systems and methods for developing personalized intervention strategies for advanced driver assistance systems (ADAS) based on in-cabin sensing data and related driving context information. In one embodiment, a method for a vehicle comprises, generating a driver profile of a driver of the vehicle, the driver profile including driving style data of the driver, the driving style data including at least a braking style; an acceleration style; a steering style; and one or more preferred cruising speeds of the driver; estimating a cognitive state of a driver of a vehicle; and adjusting one or more actuator controls of an ADAS based on the estimated cognitive state of the driver, the driver profile of the driver, and route/traffic info of the vehicle.

### CROSS REFERENCE TO RELATED APPLICATION

The present application claims priority to U.S. Provisional Application No. 63/266,043, entitled “METHODS AND SYSTEMS FOR PERSONALIZED ADAS INTERVENTION”, and filed on Dec. 27, 2021. The entire contents of the above-listed application are hereby incorporated by reference for all purposes.

### FIELD

The disclosure relates generally to advanced driver assistance systems (ADAS), and more specifically, to customization of ADAS interventions.

### BACKGROUND

A vehicle may have one or more advanced driver assistance systems (ADAS), which may assist a driver of the vehicle during operation of the vehicle. An ADAS may adjust one or more actuator controls of the vehicle, such as an accelerator pedal, a brake pedal, or a steering wheel, based on data outputted by sensors of the vehicle. The sensors may include external sensors. For example, an external proximity sensor may detect a proximity of a second vehicle operating near the vehicle. In some situations, the ADAS may adjust the one or more actuator controls of the vehicle automatically, where the one or more actuator controls do not receive an input from the driver. In other situations, the one or more actuator controls may receive the input from the driver, and the ADAS may adjust an input of the driver to the one or more actuator controls. For example, when a distance between the vehicle and a leading vehicle decreases below a threshold distance and the driver does not apply brakes of the vehicle, the ADAS may apply the brakes (e.g., to assist the driver in maintaining a suitable following distance). Alternatively, if a pressure applied to the brakes by the driver is below a threshold pressure, the ADAS may increase the pressure on the brakes (e.g., to maintain the suitable following distance).

Current ADAS systems typically rely on pre-defined patterns in sensor data. If a pre-defined pattern in the sensor data is detected, an ADAS system may respond by adjusting one or more actuator controls of the vehicle accordingly. For example, one pre-defined pattern may be a gradual drift of the vehicle to one side of a lane of traffic. If the gradual drift is detected based on an output of an external sensor (e.g., a camera mounted on a front end of the vehicle), the ADAS system may adjust a steering wheel of the vehicle to maintain the vehicle at a center of the lane (e.g., a lane-keep-assist adjustment). However, the adjustment of the ADAS system may not be customized to the driver, whereby a response to a pre-defined pattern may be the same for a plurality of different drivers. Because each driver may have a different driving style, not all drivers may be satisfied with the response. For example, a first driver may consider a lane-keep-assist adjustment to be aggressive, while a second driver may consider the lane-keep-adjustment to be not aggressive enough. As a result, drivers may disable an ADAS system due to dissatisfaction with responses of the ADAS system, whereby a benefit of the ADAS system may be lost.

### SUMMARY

In various embodiments, the issue described above may be addressed by a method for a vehicle, comprising generating a driver profile of a driver of the vehicle, the driver profile including driving style data of the driver, the driving style data including at least a braking style; an acceleration style; a steering style; and one or more preferred cruising speeds of the driver; estimating a cognitive state of a driver of a vehicle; and adjusting one or more actuator controls of an advanced driver-assistance system (ADAS) based on the estimated cognitive state of the driver, the driver profile of the driver, and route/traffic info of the vehicle. By basing an adjustment of the one or more actuator controls of the ADAS on the estimated cognitive state of the driver, the driver profile of the driver, and route/traffic info of the vehicle, the adjustment may be personalized to the driver.

For example, if the ADAS intervenes because the driver does not apply sufficient pressure to brakes of the vehicle (e.g., because the driver is drowsy, distracted, stressed, or experiencing a high cognitive load), the ADAS may apply additional pressure to the brakes in a manner consistent with the driver's driving style. For example, if the driver typically applies pressure to the brakes in a short, intense manner, the ADAS system may intervene later with a short, intense pressure on the brakes. If the driver typically applies pressure to the brakes in a long, cautious manner, the ADAS system may intervene earlier with a long, cautious pressure on the brakes. Alternatively, a personalized ADAS intervention may include applying pressure to the brakes in a manner that is intentionally inconsistent with the driver's driving style. For example, if the driver typically applies pressure to the brakes in the short, intense manner, the ADAS system may intervene with a long, cautious pressure on the brakes, and if the driver typically applies pressure to the brakes in a long, cautious manner, the ADAS system may intervene with a short, intense pressure on the brakes. By intervening in a manner that is inconsistent with a typical or preferred manner of the driver, the ADAS system may prompt the driver to take over control of the vehicle in the typical or preferred manner, thereby reducing a dependence on the ADAS system. In various embodiments, a personalized ADAS intervention may include an adjustment that may optimally “wake up” a driver based on the driver's driving style. It should be appreciated that the examples provided herein are for illustrative purposes, and different types of interventions may be generated without departing from the scope of this disclosure.

In this way, an intervention strategy for an ADAS may be created that is customized for a driver, where a custom response of the ADAS may be provided to the driver based on the driving style of the driver and a current cognitive and/or physiological state of the driver. By providing customized responses to driver behavior, rather than standard responses based on an average driver, a level of driver satisfaction with the ADAS may be increased, leading to increased acceptance of and reliance on the ADAS. An additional benefit of the systems and methods disclosed herein is that the intervention strategy and ADAS actuator adjustments may be performed by an ADAS controller based on flexible business logic that may be customizable via an ADAS software development kit (SDK), such that manufacturers can customize the inputs and parameters of the ADAS controller to generate a desired custom behavior of the ADAS controller. Further, in some embodiments, the customized intervention strategy may be applied based on passengers of a vehicle, such as in a taxi or autonomous vehicle context. For example, a driving style of an autonomous vehicle may be adjusted based on a driving style and cognitive state of one or more passengers of the vehicle.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The disclosure may be better understood from reading the following description of non-limiting embodiments, with reference to the attached drawings, wherein below:

FIG. 1 is a schematic block diagram of a vehicle control system, in accordance with one or more embodiments of the present disclosure;

FIG. 2 is a schematic block diagram that shows examples of data that may be received as input into a controller of a vehicle control system, in accordance with one or more embodiments of the present disclosure;

FIG. 3 is a diagram showing a vehicle in communication with a cloud-based database including a model of a driver of a vehicle, in accordance with one or more embodiments of the present disclosure;

FIG. 4 is a flowchart illustrating an exemplary method for adjusting actuator controls of an ADAS of a vehicle based on driver data, in accordance with one or more embodiments of the present disclosure;

FIG. 5 is a flowchart illustrating an exemplary method for adjusting actuator controls of an ADAS of a vehicle based on passenger data, in accordance with one or more embodiments of the present disclosure;

FIG. 6 shows an exemplary dashboard of a vehicle including a plurality of controls, in accordance with one or more embodiments of the present disclosure; and

FIG. 7 is a schematic block diagram that shows an in-vehicle computing system and a control system of a vehicle, in accordance with one or more embodiments of the present disclosure.

### DETAILED DESCRIPTION

The following detailed description relates to a framework for a personalized intervention strategy for an advanced driver assistance system (ADAS) of a vehicle. In various embodiments, the personalized intervention strategy may be based on driving style information of a driver of the vehicle, driver status information of the driver, and route/traffic data of the vehicle. The driving style information may include, for example, an acceleration style, a braking style, a steering style, and one or more preferred cruising speeds of the driver. The driver status information may be information relevant to a cognitive and/or physiological state of the driver, and may include, for example, a level of drowsiness, a level of distraction, a level of cognitive load, and/or a level of stress of the driver at a point in time. The driving style information may be collected from sensors of the vehicle, such as speed sensors and/or actuator sensors (e.g., accelerator, brake, and steering wheel sensors), and may be accumulated over time and used to generate a driver model. The driver status information may be collected via a driver monitoring system (DMS) of the vehicle and in-cabin sensors, such as seat sensors and/or microphones arranged within a cabin of the vehicle.

In accordance with the personalized ADAS intervention strategy, the ADAS may adjust one or more actuator controls of the vehicle based on the driver status and driving style, route information received from a navigational system of the vehicle, from one or more external sensors of the vehicle. For example, if the ADAS detects that the driver is drowsy while the vehicle is being operated in a high traffic scenario, the ADAS may adjust actuator controls of the vehicle to apply the brakes more frequently, where an application of the brakes is based on a braking style of the driver.

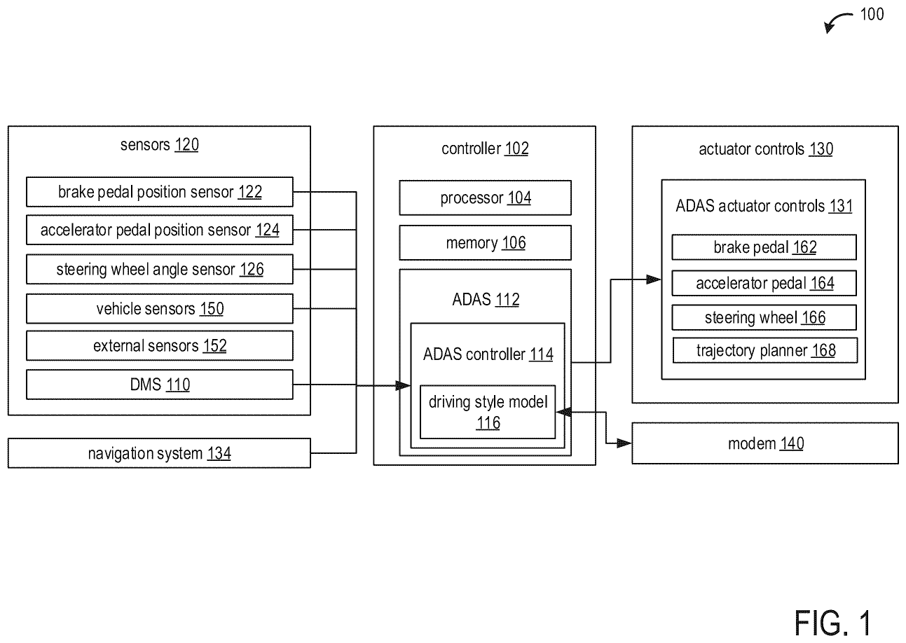

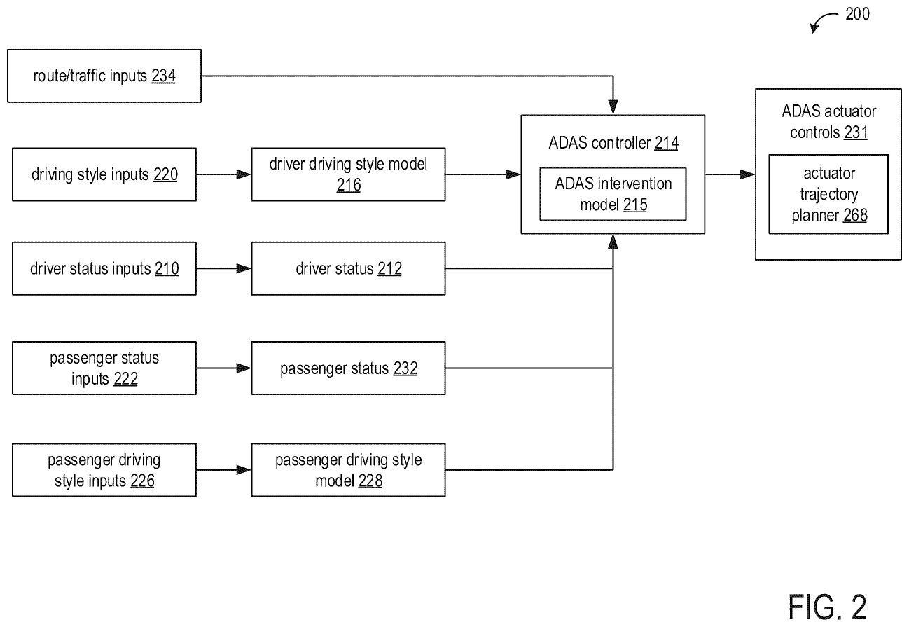

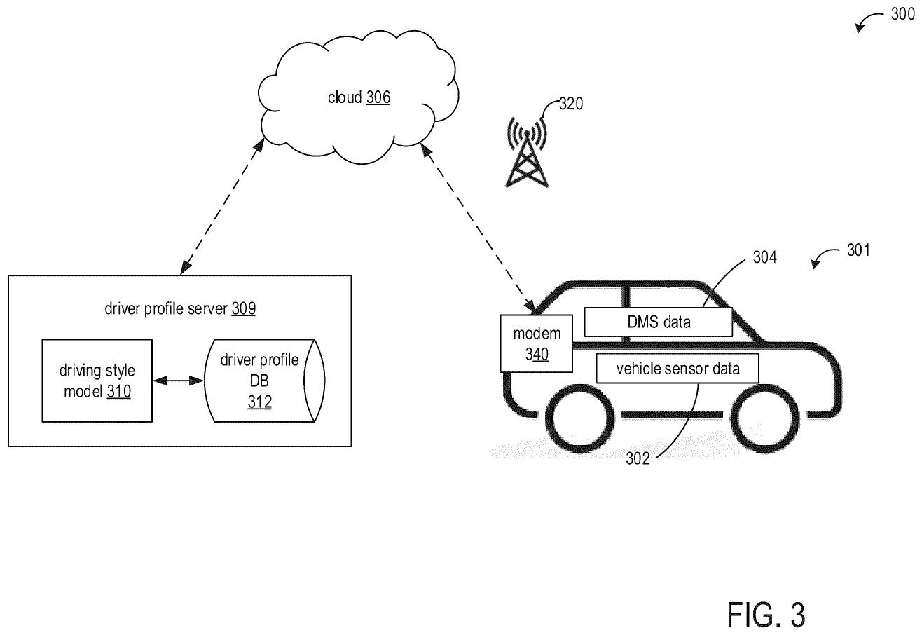

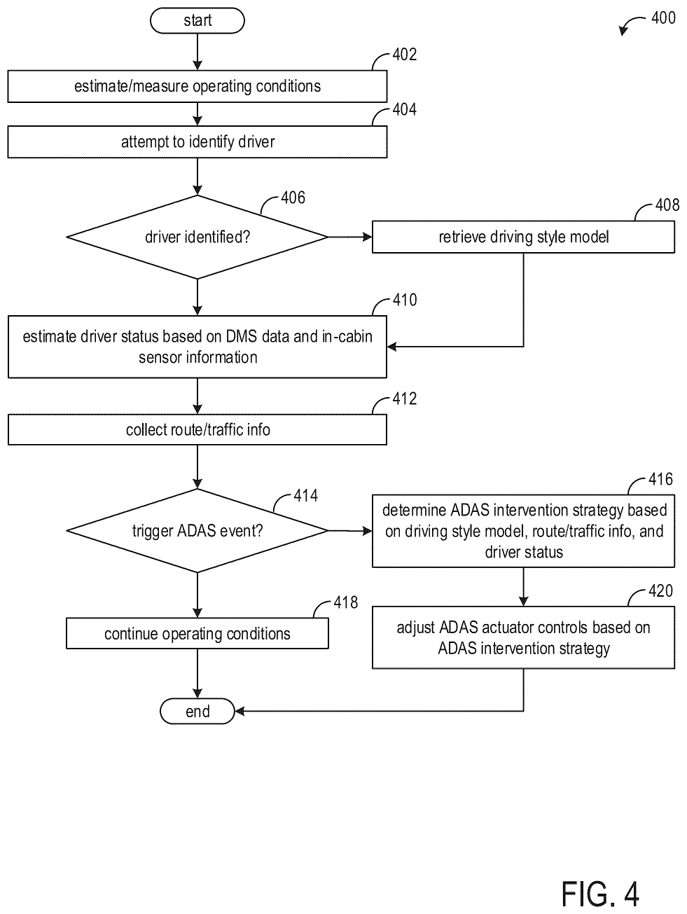

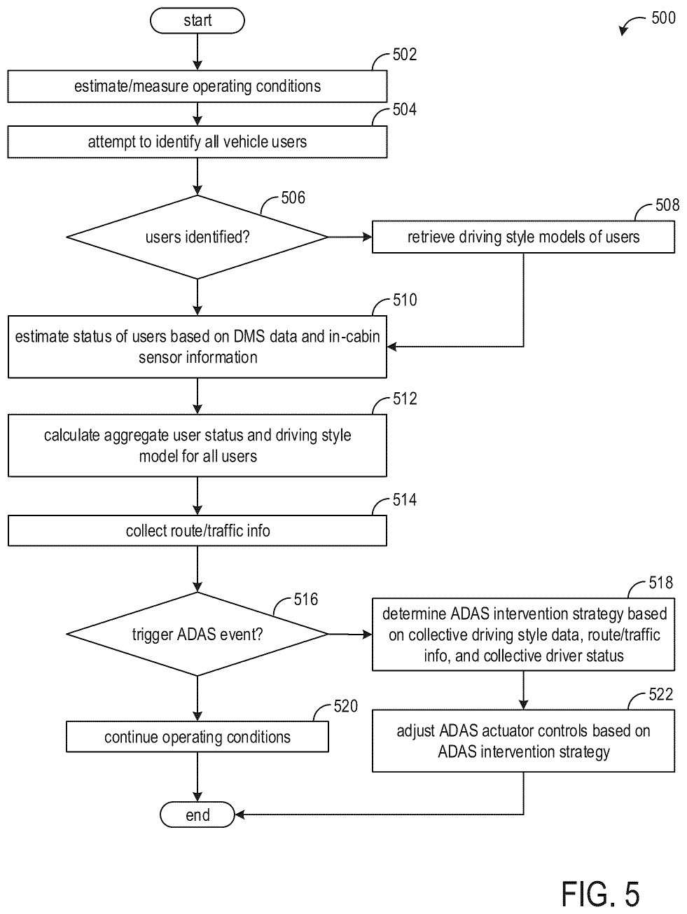

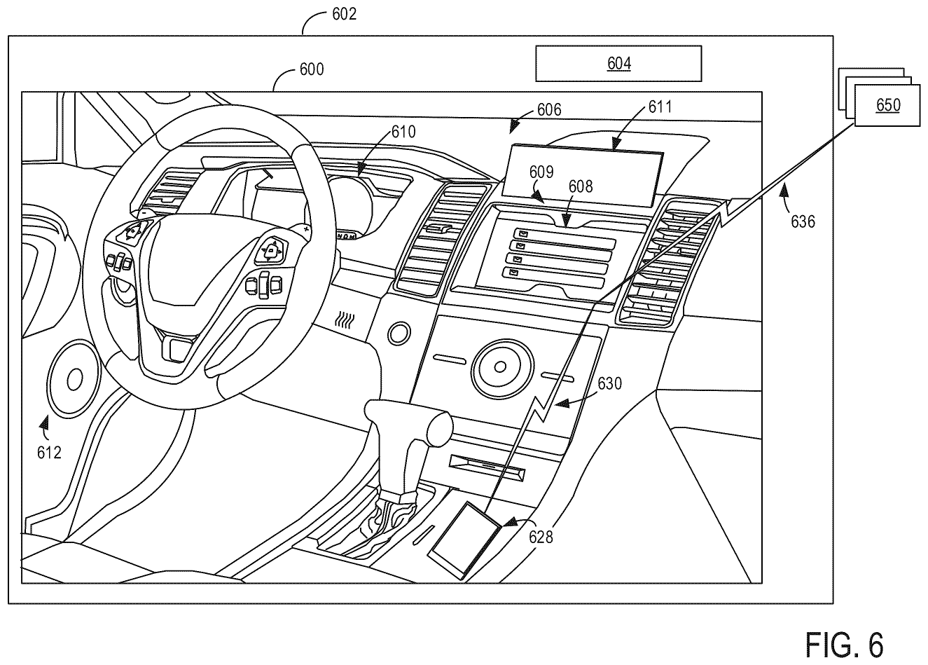

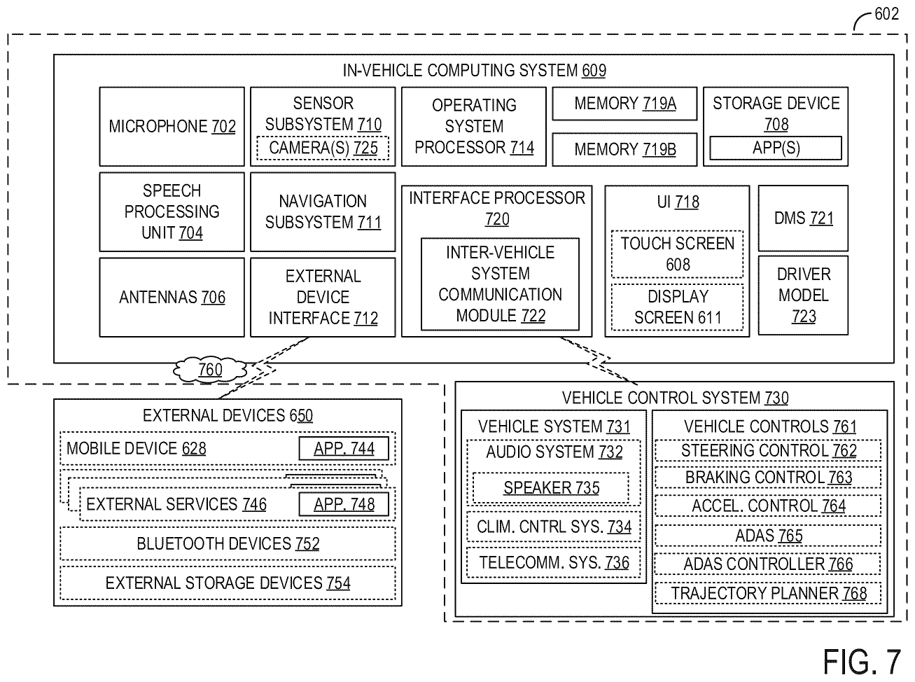

FIG. 1 shows a control system of a vehicle, the control system including an ADAS that receives inputs from various sensors and systems and controls a plurality of ADAS actuator controls of the vehicle. FIG. 2 shows a flow of data from the various sensors and systems to an ADAS controller of the ADAS for controlling the ADAS actuator controls. An input into the ADAS controller may be a driving style model of a driver of the vehicle, which may be generated at and retrieved from a cloud-based server, as shown in FIG. 3. FIG. 4 shows a first exemplary procedure of the ADAS controller for controlling the ADAS actuator controls based on route/traffic information and the driving style model and cognitive status of the driver. FIG. 5 shows a second exemplary procedure of the ADAS controller for controlling the ADAS actuator controls based on route/traffic information and a plurality of driving style models and cognitive statuses of a respective plurality of users of the vehicle, the users including passengers of the vehicle. FIG. 6 shows an exemplary set of dashboard controls of a cabin of the vehicle. FIG. 7 shows various systems and subsystems of an in-vehicle computing system including a vehicle control system.

Referring now to FIG. 1, a simplified vehicle control system 100 of a vehicle is shown, including a controller 102, a plurality of sensors 120, and a plurality of actuator controls 130. Controller 102 may include a processor 104, which may execute instructions stored on a memory 106 to establish actuator controls 130 based at least partly on an output of sensors 120.

As discussed herein, the memory 106 may include any non-transitory computer readable medium in which programming instructions are stored. For the purposes of this disclosure, the term “tangible computer readable medium” is expressly defined to include any type of computer readable storage. The example methods and systems may be implemented using coded instruction (e.g., computer readable instructions) stored on a non-transitory computer readable medium such as a flash memory, a read-only memory (ROM), a random-access memory (RAM), a cache, or any other storage media in which information is stored for any duration (e.g. for extended period time periods, permanently, brief instances, for temporarily buffering, and/or for caching of the information). Computer memory of computer readable storage mediums as referenced herein may include volatile and non-volatile or removable and non-removable media for a storage of electronic-formatted information such as computer readable program instructions or modules of computer readable program instructions, data, and so on that may be stand-alone or as part of a computing device. Examples of computer memory may include any other medium which can be used to store the desired electronic format of information and which can be accessed by the processor or processors or at least a portion of a computing device.

Controller 102 may include an ADAS 112. ADAS 112 may adjust one or more ADAS actuator controls 131 of actuator controls 130 to assist the driver in operating the vehicle under certain circumstances. In various embodiments, ADAS actuator controls 131 may include a brake pedal 162, an accelerator pedal 164, and a steering wheel 166. Additionally, ADAS actuator controls may include a trajectory planner 168, which may provide for an indirect actuator adjustment (e.g., of brake pedal 162, accelerator pedal 164, and/or steering wheel 166) based on a planned trajectory from a current position of the vehicle to a target position of the vehicle.

For example, a driver may be following a lead vehicle within a threshold following distance, where an ADAS intervention may occur. In a first scenario, ADAS controller 114 may adjust a first pressure on brake pedal 162 to slow the vehicle down, thereby increasing the following distance. In a second scenario, ADAS controller 114 may use trajectory planner 168 to calculate a planned trajectory of the vehicle from a current position of the vehicle to a target position of the vehicle, where the target position is a position at which the following distance between the vehicle and the lead vehicle is greater than the threshold following distance. To execute the planned trajectory, the controller may apply a second pressure on brake pedal 162, which may be different than the first pressure. For example, the first pressure may be a pressure applied at a first, consistent rate to slow the vehicle down, and the second pressure may be a pressure applied at a second rate, where the second rate may apply different rates of pressure over different durations to achieve the target position.

In other embodiments, more, or fewer, or different actuator controls of the vehicle may be included in ADAS actuator controls 131.

ADAS 112 may adjust ADAS actuator controls 131 via an ADAS controller 114. ADAS controller 114 may include a driving style model 116. Driving style model 116 may be a personalized model of a driving style of a driver of the vehicle. For example, the driving style of the driver may include a braking style of the driver, an acceleration style of the driver, a steering style of the driver, one or more preferred cruising speeds of the driver, and/or other driving style data. In various embodiments, ADAS controller 114 may adjust ADAS actuator controls 131 based at least partly on driving style model 116. For example, an adjustment of brake pedal 162 may be based at least partly on the braking style of the driver included in driving style model 116; an adjustment of accelerator pedal 164 may be based at least partly on the acceleration style of the driver included in driving style model 116; and an adjustment of steering wheel 166 may be based at least partly on the steering style of the driver included in driving style model 116.

ADAS controller 114 may receive inputs from one or more sensors 120 of the vehicle, and may adjust one or more of ADAS actuator controls 131 based on the inputs in accordance with a logic of ADAS controller 114. In some embodiments, the logic of ADAS controller 114 may be a flexible logic that is configurable, for example, by a manufacturer of the vehicle. For example, a first manufacturer may configure the logic of ADAS controller 114 to adjust a first set of the one or more ADAS actuator controls 131 based on a first set of inputs and/or a first set of parameters; a second manufacturer may configure the logic of ADAS controller 114 to adjust a second set of the one or more ADAS actuator controls 131 based on a second set of inputs and/or a second set of parameters; and so on.

The one or more sensors 120 of the vehicle may include a brake pedal position sensor 122, an accelerator pedal position sensor 124, and a steering wheel angle sensor 126. As described in greater detail herein, sensor data received by ADAS controller 114 from brake pedal position sensor 122, accelerator pedal position sensor 124, and steering wheel angle sensor 126 may be collected by controller 102 and/or ADAS controller 114 and used to generate driving style model 116.

The one or more sensors 120 of the vehicle may include one or more vehicle sensors 150. Data outputted by vehicle sensors 150 may be an input into ADAS controller 114. Vehicle sensors 150 may include, for example, engine speed and/or wheel speed sensors, which may indicate a speed of the vehicle or used to calculate acceleration of the vehicle. Vehicle sensors 150 may include one or more in-cabin sensors arranged within a cabin of the vehicle. The one or more in cabin sensors may include one or more cameras, such as a dashboard camera, which may be used to collect images of the driver and/or passengers of the vehicle for further processing. The one or more in-cabin sensors may include one or more microphones arranged on a dashboard of the vehicle and/or a different part of the cabin of the vehicle, which may be used to determine a level of noise within the cabin and/or generate contextual data based on audio signals detected within the cabin. The one or more in-cabin sensors may include one or more seats sensors of the vehicle, which may be used to determine a seat occupancy of the vehicle and/or identify one or more passengers and/or types of passengers.

The one or more sensors 120 of the vehicle may include one or more external sensors 152, and sensor data of external sensors 152 may be an input into ADAS controller 114. External sensors 152 may include, for example, one or more external cameras, such as a front end camera and a rear end camera; radar, lidar, and/or proximity sensors of the vehicle, which may detect a proximity of objects (e.g., other vehicles) to the vehicle; sensors of a windshield wiper, lights, and/or a sunroof, which may be used to determine an environmental context of the vehicle; and/or sensors of one or more indicator lights to the vehicle, which may be used to determine a traffic scenario of the vehicle.

The one or more sensors 120 may include a DMS 110. DMS 110 may monitor the driver to detect or measure aspects of a cognitive state of the driver, for example, via a dashboard camera of the vehicle, or via one or more sensors arranged in the cabin of the vehicle. Biometric data of the driver (e.g., vital signs, galvanic skin response, and so on) may be collected from a sensor of a driver's seat of the vehicle, or a sensor on a steering wheel of the vehicle, or a different sensor in the cabin. DMS 110 may analyze dashboard camera data, biometric data, and other data of the driver to generate an output. In various embodiments, the output of DMS 110 may be a detected or predicted cognitive state of the driver. For example, DMS 110 may output a detected or predicted drowsiness of the driver, a detected or predicted stress level of the driver, a detected or predicted level of distraction of the driver, and/or a detected or predicted cognitive load of the driver.

The output of DMS 110 may be used by ADAS controller 114 to control one or more of ADAS actuator controls 131. For example, DMS 110 may detect a pattern in data of the driver received from the dashboard cam that may be associated with drowsiness, and as a result, may output a signal to ADAS controller 114 indicating a detected drowsiness of the driver. In response to the signal, ADAS controller 114 may adjust the one or more of ADAS actuator controls 131 (e.g., a brake of the vehicle) in accordance with an ADAS intervention strategy for the drowsiness of the driver.

Vehicle control system 100 may include a navigation system 134. Navigation system 134 may be based on a global positioning system (GPS) and may provide real-time route/traffic information of the vehicle. The real-time route/traffic information may include an active route of the vehicle selected by the driver, or an intended route of the vehicle, and/or other information about intentions of the driver and/or external context data about the environment of the vehicle. The real-time route/traffic information outputted by navigation system 134 may be an input into ADAS controller 114.

Vehicle control system 100 may include a modem 140. Modem 140 may be used by the vehicle to communicate with one or more cloud-based servers and/or cloud hosted databases. In various embodiments, driving style model 116 may be received from a driver profile stored in a cloud-hosted database of the cloud-hosted databases. For example, sensor data collected from brake pedal position sensor 122, accelerator pedal position sensor 124, and steering wheel angle sensor 126 by ADAS controller 114 may be transmitted to a cloud-based server of the one or more cloud-based servers, where the sensor data may be processed and analyzed to generate driving style model 116 and the cloud. Driving style model 116 may reside permanently in the driver profile stored in the cloud-hosted database, and may be accessed by ADAS controller 114 via modem 140. For example, when the driver initiates operation of the vehicle, ADAS controller 114 may detect and identify the driver via a key fob of the driver, and request driving style model 116 from the driver profile of the cloud-hosted database. The cloud-based server may send driving style model 116 to the vehicle, where driving style model 116 may be stored at the vehicle in memory 106. In this way, ADAS controller 114 may rely on a version of driving style model 116 that has been recently updated with the sensor data.

Referring now to FIG. 2, a data flow diagram 200 shows how data of the driver, the vehicle, and/or passengers of the vehicle may be received as inputs into an ADAS controller 214 of an ADAS of a vehicle, to generate an assistive intervention via one or more ADAS actuator controls 231 of the vehicle. ADAS controller 214 and ADAS actuator controls 231 may be non-limiting examples of ADAS controller 114 and ADAS actuator controls 131 of vehicle control system 100.

The inputs into ADAS controller 214 may include one or more route/traffic inputs 234. Route/traffic inputs 234 may include route information outputted by a navigation system of the vehicle (e.g., navigation system 134 of FIG. 1). For example, the route information may include a location of the vehicle, whether or not the driver has selected or is navigating along an active route of the navigation system, one or more destinations of the driver, a type of driving environment (e.g., urban environment, rural environment), a type of road the driver is navigating on (e.g., a multilane road, single lane road, highway, unpaved road, and so on), or a different type of information outputted by the navigation system. Route/traffic inputs 234 may also include traffic data received from one or more external sensors (e.g., external sensors 152 of FIG. 1) of the vehicle. For example, the traffic data may include a proximity of one or more other vehicles to the vehicle.

The inputs into ADAS controller 214 may include a driving style model 216 of the driver. Driving style model 216 may include one or more characterizations of a driving style of the driver, based on one or more driving style inputs 220. For example, driving style inputs 220 may include a braking style of the driver, an acceleration style of the driver, and a steering style the driver. For example, a first driver may have a first driving style, including a first braking style, a first acceleration style, and a first steering style, and a second driver may have a second driving style different from the first driving style, including a second braking style, a second acceleration style, and a second steering style, which are different from the first braking style, the first acceleration style, and the first steering style, respectively. The first braking style of the first driver may be an inpatient braking style, characterized by an abrupt manipulation of a brake pedal (e.g., brake pedal 162 of FIG. 1) and the second braking style of the second driver may be a cautious braking style, characterized by a less abrupt manipulation of the brake pedal. The first acceleration style of the first driver may be an impatient acceleration style, characterized by rapid positive and negative accelerations, and the second acceleration style of the second driver may be a cautious acceleration style, characterized by slow and steady positive and negative accelerations. The first steering style of the first driver may be an impatient steering style, characterized by fast rotational movements of a steering wheel (e.g., steering wheel 166 of FIG. 1), and the second steering style of the second driver may be a cautious steering style, characterized by slow rotational movements of the steering wheel.

Driving style inputs may also include one or more preferred cruising speeds of the driver. For example, a first driver may prefer to drive at a first cruising speed when operating the vehicle on a highway, the first cruising speed at a speed limit of the highway, and a second driver may prefer to drive at a second cruising speed when operating the vehicle on the highway, the second cruising speed above the speed limit of the highway. In various embodiments, driving style model 216 may be based on integrated, aggregated or average driving style inputs collected over a period of time. For example, driving style model 216 may be generated and updated by software running at a cloud-based server, and ADAS controller 214 may retrieve driving style model 216 from the cloud-based server.

Turning briefly to FIG. 3, a driving style model updating diagram 300 is shown, including a vehicle 301 in communication with a driver profile server 309 via a cloud 306. In various embodiments, vehicle 301 may access cloud 306 and driver profile server 309 via a wireless network, such as a wireless cellular network 320, using a modem 340 of the vehicle (e.g., modem 140 of FIG. 1). Driver profile server 309 may include a driver profile database 312, which may include a plurality of driver profiles of a respectively corresponding plurality of drivers. Each driver profile of the plurality of driver profiles may include data of a corresponding driver, such as identifying information of the driver, demographic information of the driver, current and previous vehicle usage data of the driver, preferences of the driver with respect to settings of one or more vehicles of the driver, and the like. During operation of vehicle 301, vehicle 301 may receive driver profile data corresponding to the driver, and a controller of vehicle 301 may adjust settings of vehicle 301 based on the driver profile data. For example, based on the driver profile, the controller may adjust a position of a driving seat of vehicle 301, or a preferred radio station of the driver, or a preferred interior lighting of vehicle 301, or a different setting of vehicle 301.

Each driver profile may additionally include a driving style model 310. In some embodiments, driving style model 310 may be generated at vehicle 301 based on sensor data of vehicle 301, including vehicle sensor data 302 and DMS data 304, as described above in reference to FIG. 2. In other embodiments, driving style model 310 may be generated at driver profile server 309 based on sensor data transmitted to driver profile server 309 by vehicle 301. An advantage of generating driving style model 310 at driver profile server 309 may be that computing and memory resources of driver profile server 309 may be greater than computing and memory resources of vehicle 301, whereby a driving style model generated at driver profile server 309 may detect more sophisticated patterns in a larger amount of data than may be feasible at vehicle 301. In some embodiments, a master driving style model (e.g., a master copy of driving style model 310) may be stored in driver profile database 312, and a local copy of driving style model 310 may be stored in a memory (e.g., memory 106 of FIG. 1) of vehicle 301. The local copy of driving style model 310 may be used, for example, in the absence of conductivity with wireless cellular network 320. The local copy of driving style model 310 may be updated periodically via cloud 306.

Returning to FIG. 2, the inputs into ADAS controller 214 may include a driver status 212. In various embodiments, driver status 212 may include, for example, one or more of an estimated level of stress of the driver, an estimated level of drowsiness of the driver, an estimated level of distraction of the driver, and/or an estimated cognitive load of the driver, or an estimation of a different cognitive state of the driver. It should be appreciated that the assessments described above are for illustrative purposes, and additional and/or different assessments may be included in driver status 212 without departing from the scope of this disclosure.

Driver status 212 may be determined from one or more driver status inputs 210. Driver status inputs 210 may include one or more outputs of a DMS (e.g., DMS 110 of FIG. 1) of the vehicle. The one or more outputs of the DMS may include a detection or assessment of the cognitive state of the driver. For example, the DMS may generate an assessment of a drowsiness of the driver based on a pattern of head and/or eye movements in images captured by a dashboard camera of the vehicle. In some embodiments, the one or more outputs of the DMS may also include raw data of the DMS. For example, images collected at an in-cabin camera (e.g., dashboard camera) of the vehicle, audio signals recorded by a microphone arranged in a cabin of the vehicle, and/or biometric data collected via sensors arranged in the cabin may be used to generate driver status 212, along with one or more detections or assessments of the cognitive state of the driver. Driver status inputs 210 may further include outputs of one or more in-vehicle sensors of the vehicle, such as an in-cabin microphone, steering wheel sensors, seat sensors, and the like. In some embodiments, driver status 212 may be generated based on a driver status model that takes driver status inputs 210 as inputs, and outputs one or more estimated cognitive states of the driver. The driver status model may be a rules-based model, or a statistical model, or a machine learning model, or a combination of a rules-based model, a statistical model, and/or a machine learning model.

In some embodiments, inputs into ADAS controller 214 may include a passenger status 232 of one or more passengers. Passenger status 232 may be generated based on one or more passenger status inputs 222. Passenger status inputs 222 may include, for example, an output of an occupant monitoring system (OMS) of the vehicle, which may be a predicted cognitive state of the passenger. The OMS may predict the cognitive state of the passenger in a manner similar to the DMS described above. Passenger status inputs 222 may also include outputs of various in-cabin sensors, such one or more cameras and/or microphones arranged inside a cabin of the vehicle, one or more seat sensors, and/or other in-cabin sensors.

Inputs into ADAS controller 214 may also include a passenger driving style model 228 of one or more of the one or more passengers. In various embodiments, passenger driving style model 228 may be the driving style model of the passenger. In other words, if a driving style model (e.g., driving style model 216) is generated for a first driver of a first vehicle, and the first driver rides as a passenger of a second driver of a second vehicle, ADAS controller 214 may base an intervention strategy (e.g., to intervene in the first driver's control of the vehicle) at least partly on a driving style model of the second driver (operating the vehicle), and on passenger driving style model 228, which may be a driving style model of the first driver (now riding as a passenger).

For example, if the vehicle is being operated by a professional driver, an ADAS intervention into the professional driver's control of the vehicle may be based at least partly on cognitive statuses and driving styles of passengers of the vehicle. For example, if it is detected that the passengers of the vehicle are experiencing stress (e.g., from an OMS system of the vehicle), an ADAS intervention may be triggered at a first time and/or based on a first set of inputs, while if the passengers of the vehicle are detected to be experiencing stress, the ADAS intervention may be triggered at a second, different time and/or based on a second, different set of inputs (e.g., route/traffic inputs 234, driving style inputs 220, driver status inputs 210, passenger status inputs 222, and one or more passenger driving style inputs 226). Additionally, or alternatively, the ADAS intervention may adjust one or more ADAS actuator controls 231 in a manner that mimics a collective driving style of the passengers to reduce the stress of the passengers.

As another example, the vehicle may be an autonomous vehicle operated by one or more passengers of the vehicle, and ADAS controller 214 may control operation of the vehicle via an actuation of ADAS actuator controls 231. In such cases, ADAS controller 214 may actuate ADAS actuator controls 231 based on an aggregate of passenger statuses (such as passenger status 232) of the one or more passengers, and/or an aggregate of passenger driving style models (such as passenger driving style model 228) of the one or more passengers. As described above in reference to FIG. 1, in some embodiments, ADAS controller 214 may control ADAS actuator controls 231 via a trajectory planner 268. In other words, ADAS actuator controls 231 may be applied in accordance with a planned trajectory of the vehicle (e.g., to adjust a current position of the vehicle to a target position).

ADAS controller 214 may include an ADAS intervention model 215, which may be used to determine an ADAS intervention strategy for controlling the one or more ADAS actuator controls 231. In various embodiments, ADAS intervention model 215 may be a rules-based model that determines the ADAS intervention strategy by applying one or more rules to input data received at ADAS controller 214. For example, a first rule of ADAS intervention model 215 may state that if a vehicle is drifting out of a lane of heavy traffic and driver status 212 includes a first predetermined driver status (e.g., a high level of distraction), and if driving style model 216 includes a first predetermined driving style model, then a first ADAS intervention strategy may be executed, the first ADAS intervention strategy including an immediate adjustment of a steering wheel of the vehicle in a manner consistent with the first predetermined driving style model. A second rule of ADAS intervention model 215 may state that if the vehicle is drifting out of the lane of heavy traffic and driver status 212 includes a second predetermined driver status (e.g., a low level of distraction), the first ADAS intervention strategy may not be executed, and/or a second ADAS intervention strategy may be executed in the manner consistent with the first driving style model. A third rule of ADAS intervention model 215 may state that if the vehicle is drifting out of the lane of heavy traffic and driver status 212 includes a third predetermined driver status (e.g., a high level of drowsiness), then a third ADAS intervention strategy may be executed, the third ADAS intervention strategy including a gentle adjustment of a steering wheel of the vehicle in a manner consistent with the first predetermined driving style model. In this way, various rules may be applied to driving data received at ADAS controller 214 to determine an appropriate ADAS intervention strategy.

In other embodiments, ADAS intervention model may be, or may include, a statistical model and/or a machine learning (ML) model. The statistical model and/or ML model may output one or more desired actuations of ADAS actuator controls 131 based on route/traffic inputs 234, driving style model 216, driver status 212, passenger status 232, and passenger driving style model 228.

Referring now to FIG. 4, an example method 400 is shown for adjusting one or more actuator controls of an ADAS system of a vehicle based on a driving style model of a driver of a vehicle, driver status data of the driver, and route/traffic information of the vehicle. The driving style model, driver status data, and route/traffic information may be non-limiting examples of driving style model 216, driver status 212, and route/traffic inputs 234 of FIG. 2, respectively. Instructions for carrying out method 400 may be executed by a controller of the vehicle, such as ADAS controller 114 of FIG. 1.

At a part 402, method 400 includes estimating and/or measuring vehicle operating conditions. For example, the vehicle operating conditions may include, but are not limited to, a status of an engine of the vehicle (e.g., whether the engine is switched on), and an engagement of one or more gears of a transmission of the vehicle (e.g., whether the vehicle is moving). Vehicle operating conditions may include engine speed and load, vehicle speed, transmission oil temperature, exhaust gas flow rate, mass air flow rate, coolant temperature, coolant flow rate, engine oil pressures (e.g., oil gallery pressures), operating modes of one or more intake valves and/or exhaust valves, electric motor speed, battery charge, engine torque output, vehicle wheel torque, and so on. In one example, the vehicle is a hybrid electric vehicle, and estimating and/or measuring vehicle operating conditions includes determining whether the vehicle is being powered by an engine or an electric motor.

At a part 404, method 400 includes attempting to identify the driver. In various embodiments, the driver may be identified by an actuation of the key fob of the driver. For example, the driver may press a button on the key fob to open a door of the vehicle or started engine of the vehicle, and the driver may be identified by data transmitted to the vehicle in a wireless signal of the key fob.

At a part 406, method 400 includes determining whether the driver has been identified. If the driver is not identified at the part 406, method 400 proceeds to a part 410. If the driver is identified at the part 406, method 400 proceeds to a part 408. At the part 408, method 400 includes retrieving a driving style model (e.g., driving style model 116 of FIG. 1) of the driver. In some embodiments, the driving style model of the driver may be retrieved from a memory of the vehicle. In other embodiments, the driving style model may be retrieved from a cloud-based driver profile database (e.g., driver profile database 312) via a cellular wireless network (e.g., wireless cellular network 320).

At the part 410, method 400 includes estimating a driver status of the driver based on DMS data and in-cabin sensor information of the vehicle, as described above in reference to FIGS. 1 and 2.

At a part 412, method 400 includes collecting route/traffic information of the vehicle. Route/traffic information may include route information outputted by a navigation system of the vehicle (e.g., navigation system 134 of FIG. 1), traffic information received from one or more external sensors (e.g., external sensors 152 of FIG. 1) of the vehicle, and/or information about a location, route, and/or environment of the vehicle collected from other sources. For example, the traffic data may include a proximity of one or more other vehicles to the vehicle. In some embodiments, the route/traffic information may include weather or climate data outputted by the one or more external sensors, or information regarding a time of operation of the vehicle (e.g., day or night).

At a part 414, method 400 includes determining whether an ADAS event has been triggered. For example, an ADAS event may be triggered if the ADAS controller detects (e.g., from an external camera of the vehicle) that the vehicle is not maintaining an appropriate following distance from a vehicle, or if the vehicle is drifting out of a lane of a road the vehicle is travelling on, or in the event of an abrupt and unexpected movement of the vehicle, such as a sudden braking event, acceleration event, or swerve of the vehicle. As other examples, an ADAS event may be triggered if the ADAS controller detects that a speed of the vehicle exceeds a posted speed limit for the road, or if the driver indicates a lane change to a desired lane when a vehicle in the desired lane is in a blind spot of the driver. If an ADAS event is not triggered at the part 414, method 400 proceeds to a part 418. At the part 418, method 400 includes continuing operating conditions of the vehicle, and method 400 ends. Alternatively, if an ADAS event is triggered at the part 414, method 400 proceeds to a part 416.

At the part 416, method 400 includes determining an appropriate ADAS intervention strategy based on the driving style model of the driver, route/traffic info, and the driver status. For example, the ADAS controller may receive data from a navigation system of the vehicle indicating that the driver may be operating the vehicle along a route in a city. The ADAS controller may receive data from external sensors of the vehicle, such as a front-end camera, a rear-end camera, and/or proximity sensors of the vehicle, indicating that the driver is operating on a multi-lane road in a high-traffic scenario. Data of the front-end camera may further indicate that the vehicle is frequently drifting away from a center of a lane of the multi-lane road, at times towards a left side of the lane, and at times towards the right side of the lane. In response to detecting the frequent drift, an ADAS intervention may be triggered, based on an ADAS intervention model (e.g., the ADAS intervention model 215 of FIG. 2).

Prior to adjusting one or more actuator controls of the vehicle (e.g., ADAS actuator controls 131), the ADAS controller may determine an appropriate ADAS strategy for intervening into driver control of the vehicle. In various embodiments, the appropriate ADAS intervention strategy may be determined by applying one or more rules of the ADAS intervention model to available driver data, including the external sensor data and the navigation system data, driving style data of the driver from the driving style model of the driver, and the driver status data.

Determining the appropriate ADAS strategy may also include determining whether a potential ADAS intervention strategy is within a personalization envelope, where the personalization envelope defines a range of possible customizations of actuator control patterns and parameters related to driving. The range of possible customizations may be based on one or more regulations or standards regulating an operation of the vehicle. For example, the range of possible customizations may be defined by a speed limit of a road the vehicle is travelling on, or a speed limit of the vehicle based on road and driving conditions; a minimum established following distance behind a lead vehicle based on a speed of the vehicle; a measured traction (e.g., anti-blocking system) of the vehicle under current road conditions; weather conditions and/or lighting conditions; whether a lane change is permitted in certain scenarios or at certain locations; or one or more different driving factors.

For example, the ADAS controller may detect that a following distance between the vehicle and a lead vehicle is below a threshold following distance, where the threshold following distance is determined based on a speed of the vehicle and one or more road conditions. The ADAS controller may additionally detect that the driver has a high level of stress (e.g., the driver status). The ADAS controller may retrieve the driving style model of the driver from a cloud-based database (e.g., driver profile database 312 of FIG. 3), and determine from the driving style model that a braking style of the driver is typically cautious. In response to the short following distance, the high level of stress, and the normally cautious braking style of the driver, an ADAS intervention may be triggered by the ADAS controller.

An ADAS intervention strategy may be based on the short following distance, the high level of stress, and the normally cautious braking style of the driver. For example, the ADAS intervention strategy may include immediately and gently applying pressure to a brake pedal (e.g., brake pedal 162) of the vehicle in a cautious manner barely detectable by the (stressed) driver, based on the following distance. An amount of pressure to apply to the brake pedal may be determined based on the personalization envelope. For example, a first, strong amount of pressure may cause the vehicle to slow down suddenly in traffic, whereby an amount of pressure selected by the ADAS controller to apply as part of the ADAS intervention strategy may be less than the first, strong amount of pressure. A second, lesser amount of pressure may not be sufficient to adequately increase the short following distance to an appropriate following distance, whereby the amount of pressure selected by the ADAS controller to apply as part of the ADAS intervention strategy may be more than the second, lesser amount of pressure.

At a part 420, method 400 includes adjusting one or more ADAS actuator controls (e.g., ADAS actuator controls 131) based on the appropriate ADAS intervention strategy. Adjusting the one or more ADAS actuator controls may include adjusting an ADAS actuator control directly, or adjusting an ADAS actuator control in accordance with a planned trajectory of the vehicle, where the planned trajectory is generated by a trajectory planner, such as trajectory planner 168 of FIG. 1 and/or trajectory planner 268 of FIG. 2. Method 400 ends.

Referring now to FIG. 5, an example method 500 is shown for adjusting one or more actuator controls of an ADAS system of a vehicle based on route/traffic information of the vehicle and a plurality of driving style models and user statuses of a respective plurality of users of a vehicle, where the users of the vehicle may include passengers. In embodiments where the vehicle is an autonomous vehicle, the users of the vehicle may be passengers that operate the autonomous vehicle, and there may not be a driver. Instructions for carrying out method 400 may be executed by a controller of the vehicle, such as ADAS controller 114 of FIG. 1.

At a part 502, method 500 includes estimating and/or measuring vehicle operating conditions, as described above in reference to method 500. At a part 504, method 500 includes attempting to identify the users of the vehicle. In some embodiments, a user (e.g., a driver, or an additional driver of the vehicle riding as a passenger) may be identified by an actuation of a key fob. In some embodiments, one or more users may be identified by images captured by an OMS of the vehicle, using facial recognition software.

At a part 506, method 500 includes determining whether one or more of the users have been identified. If no users are identified at the part 506, method 500 proceeds to a part 510. If one or more of the users are identified at the part 506, method 500 proceeds to a part 508. At the part 508, method 500 includes retrieving one or more driving style models of the one or more users. The driving style models of the users may be retrieved from a memory of the vehicle, or from a cloud-based driver profile database via a cellular wireless network.

At the part 510, method 500 includes estimating a status of the one or more users based on DMS/OMS data and in-cabin sensor information of the vehicle, as described above in reference to FIGS. 1 and 2.

At a part 512, method 500 includes collecting route/traffic information of the vehicle, as described above in reference to method 400.

At a part 514, method 500 includes calculating an aggregate user status and an aggregate driving style model for all users of the vehicle. In various embodiments, the aggregate user status may be an average of the user statuses of the one or more users, and the aggregate driving style model may include average driving style data of the one or more users. For example, the aggregate driving style model may include a braking style that is an average of the braking styles of the users; and acceleration style that is an average of the acceleration styles of the users, and a steering style that is an average of the steering styles of users. Similarly, the aggregate user status may include an average of an estimated level of drowsiness of each of the one or more users; an average of an estimated level of distraction of each of the one or more users; an average of an estimated level of distraction of each of the one or more users, and/or an average of an estimated cognitive load of each of the one or more users. In other embodiments, a different metric (e.g., not an average) may be used to determine the aggregate user status and the aggregate driving style model of the one or more users.

At a part 516, method 500 includes determining whether an ADAS event has been triggered. If an ADAS event is not triggered at the part 516, method 500 proceeds to a part 520. At the part 520, method 500 includes continuing operating conditions of the vehicle, and method 500 ends. Alternatively, if an ADAS event is triggered at the part 516, method 500 proceeds to a part 518.

At the part 518, method 500 includes determining an appropriate ADAS intervention strategy based on the aggregate driving style model, route/traffic info, and the aggregate user status. For example, the ADAS controller may receive data from a navigation system of the vehicle indicating that a driver may be operating the vehicle along a route in a city. The ADAS controller may receive data from external sensors of the vehicle, such as a front-end camera, a rear-end camera, and/or proximity sensors of the vehicle, indicating that the driver is operating on a multi-lane road in a high-traffic scenario. Data of the front-end camera may further indicate that the vehicle is frequently drifting away from a center of a lane of the multi-lane road, at times towards a left side of the lane, and at times towards the right side of the lane. In response to detecting the frequent drift, an ADAS intervention may be triggered, based on an ADAS intervention model (e.g., the ADAS intervention model 215 of FIG. 2).

Prior to adjusting one or more actuator controls of the vehicle (e.g., ADAS actuator controls 131), the ADAS controller may determine an appropriate ADAS strategy for intervening into driver control of the vehicle. In various embodiments, the appropriate ADAS intervention strategy may be determined by applying one or more rules of the ADAS intervention model to the aggregate driving style model, the aggregate user status, and the route/traffic info. As described above in reference to method 400, determining the appropriate ADAS strategy may also include determining whether a potential ADAS intervention strategy is within a personalization envelope, where the personalization envelope defines a range of possible customizations of actuator control patterns and parameters related to driving (e.g., speed limit and so on).

For example, a vehicle with a driver and a passenger may be operating on a road in traffic, the passenger a second driver of the vehicle (e.g., a spouse). The ADAS controller may detect that a following distance between the vehicle and a lead vehicle is below a threshold following distance, where the threshold following distance is determined based on a speed of the vehicle and one or more road conditions. The ADAS controller may detect that the driver has a low level of drowsiness (e.g., the driver status), and the ADAS controller may detect that a single passenger of the vehicle has a high level of drowsiness (e.g., the passenger status). The ADAS controller may identify the driver from a key fob of the driver and retrieve the driving style model of the driver from a cloud-based database. The ADAS controller may identify the passenger from a key fob of the passenger and retrieve the driving style model of the passenger from the cloud-based database. The ADAS controller may calculate an aggregate user status of the vehicle, which may include an average level of drowsiness of the driver and the passenger (e.g., greater than the level of drowsiness of the driver and less than the level of drowsiness of the passenger). The ADAS controller may calculate an aggregate driving style model of the vehicle, which may include an average braking style of the driver and the passenger. Based on the short following distance, an ADAS intervention may be triggered.

An ADAS intervention strategy may be based on the short following distance, the average level of drowsiness, and the average braking style of the driver and the passenger. For example, if the braking style of the driver is an abrupt braking style, and the braking style of the passenger is a cautious braking style, and as a result of the higher level of drowsiness of the passenger, the ADAS intervention strategy may include applying a pressure on a brake pedal of the vehicle that is more gentle than would be applied based on the driving style model and driver status of the driver alone.

At a part 522, method 500 includes adjusting one or more ADAS actuator controls (e.g., ADAS actuator controls 131) based on the appropriate ADAS intervention strategy, and method 500 ends.

FIG. 6 shows an interior of a cabin 600 of a vehicle 602, in which a driver and/or one or more passengers may be seated. Vehicle 602 of FIG. 6 may be a motor vehicle including drive wheels (not shown) and an internal combustion engine 604. Internal combustion engine 604 may include one or more combustion chambers which may receive intake air via an intake passage and exhaust combustion gases via an exhaust passage. Vehicle 602 may be a road automobile, among other types of vehicles. In some examples, vehicle 602 may include a hybrid propulsion system including an energy conversion device operable to absorb energy from vehicle motion and/or the engine and convert the absorbed energy to an energy form suitable for storage by an energy storage device. Vehicle 602 may include a fully electric vehicle, incorporating fuel cells, solar energy capturing elements, and/or other energy storage systems for powering the vehicle.

Further, in some examples, vehicle 602 may be an autonomous vehicle. In some examples, vehicle 602 is a fully autonomous vehicle (e.g., fully self-driving vehicle) configured to drive without a user input. For example, vehicle 602 may independently control vehicle systems in order to direct the vehicle to a desired location, and may sense environmental features in order to direct the vehicle (e.g., such as via object detection). In some examples, vehicle 602 is a partially autonomous vehicle. In some examples, vehicle 602 may have an autonomous mode, in which the vehicle operates without user input, and a non-autonomous mode, in which the user directs the vehicle. Further, in some examples, while an autonomous vehicle control system may primarily control the vehicle in an autonomous mode, a user may input commands to adjust vehicle operation, such as a command to change a vehicle speed, a command to brake, a command to turn, and the like. In still other examples, the vehicle may include at least one ADAS for partially controlling the vehicle, such as a cruise control system, a collision avoidance system, a lane change system, and the like.

Vehicle 602 may include a plurality of vehicle systems, including a braking system for providing braking, an engine system for providing motive power to wheels of the vehicle, a steering system for adjusting a direction of the vehicle, a transmission system for controlling a gear selection for the engine, an exhaust system for processing exhaust gases, and the like. Further, the vehicle 602 includes an in-vehicle computing system 609. The in-vehicle computing system 609 may include an autonomous vehicle control system for at least partially controlling vehicle systems during autonomous driving. As an example, while operating in an autonomous mode, the autonomous vehicle control system may monitor vehicle surroundings via a plurality of sensors (e.g., such as cameras, radars, ultrasonic sensors, a GPS signal, and the like). The in-vehicle computing system 609 is described in greater detail below in reference to FIG. 7.

As shown, an instrument panel 606 may include various displays and controls accessible to a human user (e.g., a driver or a passenger) of vehicle 602. For example, instrument panel 606 may include a touch screen 608 of an in-vehicle computing system or infotainment system 609 (e.g., an infotainment system), an audio system control panel, and an instrument cluster 610. Touch screen 608 may receive user input to the in-vehicle computing system or infotainment system 609 for controlling audio output, visual display output, user preferences, control parameter selection, and so on. In some examples, instrument panel 606 may include an input device for a user to transition the vehicle between an autonomous mode and a non-autonomous mode. For example, the vehicle includes an autonomous mode in which the autonomous vehicle control system operates the vehicle at least partially independently, and a non-autonomous mode, in which a vehicle user operates the vehicle. The vehicle user may transition between the two modes via the user input of instrument panel 606. Further, in some examples, instrument panel 606 may include one or more controls for the autonomous vehicle control system, such as for selecting a destination, setting desired vehicle speeds, setting navigation preferences (e.g., a preference for highway roads over city streets), and the like. Further still, in some examples, instrument panel 606 may include one or more controls for driver assistance programs, such as a cruise control system, a collision avoidance system, and the like. Further, additional user interfaces, not shown, may be present in other portions of the vehicle, such as proximate to at least one passenger seat. For example, the vehicle may include a row of back seats with at least one touch screen controlling the in-vehicle computing system 609.

While the example system shown in FIG. 6 includes audio system controls that may be performed via a user interface of in-vehicle computing system or infotainment system 609, such as touch screen 608 without a separate audio system control panel, in other embodiments, the vehicle may include an audio system control panel, which may include controls for a conventional vehicle audio system such as a radio, compact disc player, MP3 player, and so on. The audio system controls may include features for controlling one or more aspects of audio output via one or more speakers 612 of a vehicle speaker system. For example, the in-vehicle computing system or the audio system controls may control a volume of audio output, a distribution of sound among the individual speakers of the vehicle speaker system, an equalization of audio signals, and/or any other aspect of the audio output. In further examples, in-vehicle computing system or infotainment system 609 may adjust a radio station selection, a playlist selection, a source of audio input (e.g., from radio or CD or MP3), and so on, based on user input received directly via touch screen 608, or based on data regarding the user (such as a physical state and/or environment of the user) received via one or more external devices 650 and/or a mobile device 628. The audio system of the vehicle may include an amplifier (not shown) coupled to plurality of loudspeakers (not shown). In some embodiments, one or more hardware elements of in-vehicle computing system or infotainment system 609, such as touch screen 608, a display screen 611, various control dials, knobs and buttons, memory, processor(s), and any interface elements (e.g., connectors or ports) may form an integrated head unit that is installed in instrument panel 606 of the vehicle. The head unit may be fixedly or removably attached in instrument panel 606. In additional or alternative embodiments, one or more hardware elements of the in-vehicle computing system or infotainment system 609 may be modular and may be installed in multiple locations of the vehicle.

The cabin 600 may include one or more sensors for monitoring the vehicle, the user, and/or the environment. For example, the cabin 600 may include one or more seat-mounted pressure sensors configured to measure the pressure applied to the seat to determine the presence of a user, door sensors configured to monitor door activity, humidity sensors to measure the humidity content of the cabin, microphones to receive user input in the form of voice commands, to enable a user to conduct telephone calls, and/or to measure ambient noise in the cabin 600, and so on. It is to be understood that the above-described sensors and/or one or more additional or alternative sensors may be positioned in any suitable location of the vehicle. For example, sensors may be positioned in an engine compartment, on an external surface of the vehicle, and/or in other suitable locations for providing information regarding the operation of the vehicle, ambient conditions of the vehicle, a user of the vehicle, and so on. Information regarding ambient conditions of the vehicle, vehicle status, or vehicle driver may also be received from sensors external to/separate from the vehicle (that is, not part of the vehicle system), such as sensors coupled to external devices 650 and/or mobile device 628. Sensor data of various sensors of the vehicle may be transmitted to and/or accessed by the in-vehicle computing system 609 via a bus of the vehicle, such as a controller area network (CAN) bus.

Cabin 600 may also include one or more user objects, such as mobile device 628, that are stored in the vehicle before, during, and/or after travelling. The mobile device 628 may include a smart phone, a tablet, a laptop computer, a portable media player, and/or any suitable mobile computing device. The mobile device 628 may be connected to the in-vehicle computing system via a communication link 630. The communication link 630 may be wired (e.g., via Universal Serial Bus (USB), Mobile High-Definition Link (MHL), High-Definition Multimedia Interface (HDMI), Ethernet, and so on) or wireless (e.g., via Bluetooth®, Wi-Fi®, Wi-Fi Direct®, Near-Field Communication (NFC), cellular connectivity, and so on) and configured to provide two-way communication between the mobile device and the in-vehicle computing system. (Bluetooth® is a registered trademark of Bluetooth SIG, Inc., Kirkland, WA. Wi-Fi® and Wi-Fi Direct® are registered trademarks of Wi-Fi Alliance, Austin, Texas.) The mobile device 628 may include one or more wireless communication interfaces for connecting to one or more communication links (e.g., one or more of the example communication links described above). The wireless communication interface may include one or more physical devices, such as antenna(s) or port(s) coupled to data lines for carrying transmitted or received data, as well as one or more modules/drivers for operating the physical devices in accordance with other devices in the mobile device. For example, the communication link 630 may provide sensor and/or control signals from various vehicle systems (such as vehicle audio system, climate control system, and so on) and the touch screen 608 to the mobile device 628 and may provide control and/or display signals from the mobile device 628 to the in-vehicle systems and the touch screen 608. The communication link 630 may also provide power to the mobile device 628 from an in-vehicle power source in order to charge an internal battery of the mobile device.

In-vehicle computing system or infotainment system 609 may also be communicatively coupled to additional devices operated and/or accessed by the user but located external to vehicle 602, such as one or more external devices 650. In the depicted embodiment, external devices are located outside of vehicle 602 though it will be appreciated that in alternate embodiments, external devices may be located inside cabin 600. The external devices may include a server computing system, personal computing system, portable electronic device, electronic wrist band, electronic head band, portable music player, electronic activity tracking device, pedometer, smart-watch, GPS system, and so on. External devices 650 may be connected to the in-vehicle computing system via a communication link 636 which may be wired or wireless, as discussed with reference to communication link 630, and configured to provide two-way communication between the external devices and the in-vehicle computing system. For example, external devices 650 may include one or more sensors and communication link 636 may transmit sensor output from external devices 650 to in-vehicle computing system or infotainment system 609 and touch screen 608. External devices 650 may also store and/or receive information regarding contextual data, user behavior/preferences, operating rules, and so on. and may transmit such information from the external devices 650 to in-vehicle computing system or infotainment system 609 and touch screen 608.

In-vehicle computing system or infotainment system 609 may analyze the input received from external devices 650, mobile device 628, and/or other input sources and select settings for various in-vehicle systems (such as climate control system or audio system), provide output via touch screen 608 and/or speakers 612, communicate with mobile device 628 and/or external devices 650, and/or perform other actions based on the assessment. In some embodiments, all or a portion of the assessment may be performed by the mobile device 628 and/or the external devices 650.

In some embodiments, one or more of the external devices 650 may be communicatively coupled to in-vehicle computing system or infotainment system 609 indirectly, via mobile device 628 and/or another of the external devices 650. For example, communication link 636 may communicatively couple external devices 650 to mobile device 628 such that output from external devices 650 is relayed to mobile device 628. Data received from external devices 650 may then be aggregated at mobile device 628 with data collected by mobile device 628, the aggregated data then transmitted to in-vehicle computing system or infotainment system 609 and touch screen 608 via communication link 630. Similar data aggregation may occur at a server system and then transmitted to in-vehicle computing system or infotainment system 609 and touch screen 608 via communication link 636 and/or communication link 630.

FIG. 7 shows a block diagram of an in-vehicle computing system or infotainment system 609 configured and/or integrated inside vehicle 602. In-vehicle computing system or infotainment system 609 may perform one or more of the methods described herein in some embodiments. In some examples, the in-vehicle computing system or infotainment system 609 may be a vehicle infotainment system configured to provide information-based media content (audio and/or visual media content, including entertainment content, navigational services, and so on) to a vehicle user to enhance the operator's in-vehicle experience. The in-vehicle computing system or infotainment system 609 may include, or be coupled to, various vehicle systems, sub-systems, hardware components, as well as software applications and systems that are integrated in, or integratable into, vehicle 602 in order to enhance an in-vehicle experience for a driver and/or a passenger. Further, the in-vehicle computing system may be coupled to systems for providing autonomous vehicle control.

In-vehicle computing system or infotainment system 609 may include one or more processors including an operating system processor 714 and an interface processor 720. Operating system processor 714 may execute an operating system on the in-vehicle computing system, and control input/output, display, playback, and other operations of the in-vehicle computing system. Interface processor 720 may interface with a vehicle control system 730 via an inter-vehicle system communication module 722.

Inter-vehicle system communication module 722 may output data to one or more other vehicle systems 731 and/or one or more other vehicle control elements 761, while also receiving data input from other vehicle systems 731 and other vehicle control elements 761, e.g. by way of vehicle control system 730. When outputting data, inter-vehicle system communication module 722 may provide a signal via a bus corresponding to any status of the vehicle, the vehicle surroundings, or the output of any other information source connected to the vehicle. Vehicle data outputs may include, for example, analog signals (such as current velocity), digital signals provided by individual information sources (such as clocks, thermometers, location sensors such as GPS sensors, and so on), digital signals propagated through vehicle data networks (such as an engine CAN bus through which engine related information may be communicated, a climate control CAN bus through which climate control related information may be communicated, and a multimedia data network through which multimedia data is communicated between multimedia components in the vehicle). For example, vehicle data outputs may be output to vehicle control system 730, and vehicle control system 730 may adjust vehicle control elements 761 based on the vehicle data outputs. As another example, the in-vehicle computing system or infotainment system 609 may retrieve from the engine CAN bus the current speed of the vehicle estimated by the wheel sensors, a power state of the vehicle via a battery and/or power distribution system of the vehicle, an ignition state of the vehicle, and so on. In addition, other interfacing means such as Ethernet may be used as well without departing from the scope of this disclosure.

A storage device 708 may be included in in-vehicle computing system or infotainment system 609 to store data such as instructions executable by operating system processor 714 and/or interface processor 720 in non-volatile form. The storage device 708 may store application data, including prerecorded sounds, to enable the in-vehicle computing system or infotainment system 609 to run an application for connecting to a cloud-based server and/or collecting information for transmission to the cloud-based server. The application may retrieve information gathered by vehicle systems/sensors, input devices (e.g., a user interface 718), data stored in one or more storage devices, such as a volatile memory 719A or a non-volatile memory 719B, devices in communication with the in-vehicle computing system (e.g., a mobile device connected via a Bluetooth® link), and so on. In-vehicle computing system or infotainment system 609 may further include a volatile memory 719A. Volatile memory 719A may be RAM. Non-transitory storage devices, such as and/or non-volatile memory 719B, may store instructions and/or code that, when executed by a processor (e.g., operating system processor 714 and/or interface processor 720), controls the in-vehicle computing system or infotainment system 609 to perform one or more of the actions described in the disclosure.

A microphone 702 may be included in the in-vehicle computing system or infotainment system 609 to receive voice commands from a user, to measure ambient noise in the vehicle, to determine whether audio from speakers of the vehicle is tuned in accordance with an acoustic environment of the vehicle, and so on. A speech processing unit 704 may process voice commands, such as the voice commands received from the microphone 702. In some embodiments, in-vehicle computing system or infotainment system 609 may also be able to receive voice commands and sample ambient vehicle noise using a microphone included in an audio system 732 of the vehicle.

One or more additional sensors may be included in a sensor subsystem 710 of the in-vehicle computing system or infotainment system 609. For example, the sensor subsystem 710 may include a plurality of cameras 725, such as a rear view camera for assisting a user in parking the vehicle and/or other external cameras, radars, lidars, ultrasonic sensors, and the like. The sensor subsystem 710 may include an in-cabin camera (e.g., a dashboard cam) for identifying a user (e.g., using facial recognition and/or user gestures). For example, an in-cabin camera may be used to identify one or more users of the vehicle via facial recognition software, and/or to detect a status or state of the one or more users (e.g., drowsy, distracted, stressed, high cognitive load, and so on) Sensor subsystem 710 of in-vehicle computing system or infotainment system 609 may communicate with and receive inputs from various vehicle sensors and may further receive user inputs. For example, the inputs received by sensor subsystem 710 may include transmission gear position, transmission clutch position, gas pedal input, brake input, transmission selector position, vehicle speed, engine speed, mass airflow through the engine, ambient temperature, intake air temperature, and so on, as well as inputs from climate control system sensors (such as heat transfer fluid temperature, antifreeze temperature, fan speed, passenger compartment temperature, desired passenger compartment temperature, ambient humidity, and so on), an audio sensor detecting voice commands issued by a user, a fob sensor receiving commands from and optionally tracking the geographic location/proximity of a fob of the vehicle, and so on.

One or more additional sensors may be included in and/or communicatively coupled to a sensor subsystem 710 of the in-vehicle computing system 609. For example, the sensor subsystem 710 may include and/or be communicatively coupled to a camera, such as a rear view camera for assisting a user in parking the vehicle, a cabin camera for identifying a user, and/or a front view camera to assess quality of the route segment ahead. The above-described cameras may also be used to provide images to a computer vision-based facial recognition and/or facial analysis module. For example, the facial analysis module may be used to determine an emotional or psychological state of users of the vehicle. Sensor subsystem 710 of in-vehicle computing system 609 may communicate with and receive inputs from various vehicle sensors and may further receive user inputs.

While certain vehicle system sensors may communicate with sensor subsystem 710 alone, other sensors may communicate with both sensor subsystem 710 and vehicle control system 730, or may communicate with sensor subsystem 710 indirectly via vehicle control system 730. Sensor subsystem 710 may serve as an interface (e.g., a hardware interface) and/or processing unit for receiving and/or processing received signals from one or more of the sensors described in the disclosure.

A navigation subsystem 711 of in-vehicle computing system or infotainment system 609 may generate and/or receive navigation information such as location information (e.g., via a GPS sensor and/or other sensors from sensor subsystem 710), route guidance, traffic information, point-of-interest (POI) identification, and/or provide other navigational services for the user. Navigation sub-system 711 may include inputs/outputs including analog to digital converters, digital inputs, digital outputs, network outputs, radio frequency transmitting devices, and so on. In some examples, navigation sub-system 711 may interface with vehicle control system 730.

An external device interface 712 of in-vehicle computing system or infotainment system 609 may be coupleable to and/or communicate with one or more external devices 650 located external to vehicle 602. While the external devices are illustrated as being located external to vehicle 602, it is to be understood that they may be temporarily housed in vehicle 602, such as when the user is operating the external devices while operating vehicle 602. In other words, the external devices 650 are not integral to vehicle 602. The external devices 650 may include a mobile device 628 (e.g., connected via a Bluetooth®, NFC, WI-FI Direct®, or other wireless connection) or an alternate Bluetooth®-enabled device 752.

Mobile device 628 may be a mobile phone, smart phone, wearable devices/sensors that may communicate with the in-vehicle computing system via wired and/or wireless communication, or other portable electronic device(s). Other external devices include one or more external services 746. For example, the external devices may include extra-vehicular devices that are separate from and located externally to the vehicle. Still other external devices include one or more external storage devices 754, such as solid-state drives, pen drives, USB drives, and so on. External devices 650 may communicate with in-vehicle computing system or infotainment system 609 either wirelessly or via connectors without departing from the scope of this disclosure. For example, external devices 650 may communicate with in-vehicle computing system or infotainment system 609 through the external device interface 712 over a network 760, a USB connection, a direct wired connection, a direct wireless connection, and/or other communication link.

The external device interface 712 may provide a communication interface to enable the in-vehicle computing system to communicate with mobile devices associated with contacts of the driver. For example, the external device interface 712 may enable phone calls to be established and/or text messages (e.g., Short Message Service (SMS), Multimedia Message Service (MMS), and so on) to be sent (e.g., via a cellular communication network) to a mobile device associated with a contact of the driver. The external device interface 712 may additionally or alternatively provide a wireless communication interface to enable the in-vehicle computing system to synchronize data with one or more devices in the vehicle (e.g., the driver's mobile device) via Wi-Fi Direct®, as described in more detail below.

One or more applications 744 may be operable on mobile device 628. As an example, a mobile device application 744 may be operated to aggregate user data regarding interactions of the user with the mobile device. For example, mobile device application 744 may aggregate data regarding music playlists listened to by the user on the mobile device, telephone call logs (including a frequency and duration of telephone calls accepted by the user), positional information including locations frequented by the user and an amount of time spent at each location, and so on. The collected data may be transferred by application 744 to external device interface 712 over network 760. In addition, specific user data requests may be received at mobile device 628 from in-vehicle computing system or infotainment system 609 via the external device interface 712. The specific data requests may include requests for determining where the user is geographically located, an ambient noise level and/or music genre at the user's location, an ambient weather condition (temperature, humidity, and so on) at the user's location, and so on. Mobile device application 744 may send control instructions to components (e.g., microphone, amplifier, and so on) or other applications (e.g., navigational applications) of mobile device 628 to enable the requested data to be collected on the mobile device or requested adjustment made to the components. Mobile device application 744 may then relay the collected information back to in-vehicle computing system or infotainment system 609.

Likewise, one or more applications 748 may be operable on external services 746. As an example, external services applications 748 may be operated to aggregate and/or analyze data from multiple data sources. For example, external services applications 748 may aggregate data from one or more social media accounts of the user, data from the in-vehicle computing system (e.g., sensor data, log files, user input, and so on), data from an internet query (e.g., weather data, POI data), and so on. The collected data may be transmitted to another device and/or analyzed by the application to determine a context of the driver, vehicle, and environment and perform an action based on the context (e.g., requesting/sending data to other devices).

The one or more applications 748 operable on external services 746 may include a cloud-based driver model generation service, which may receive data of a driver of the vehicle from the vehicle 602. The data of the driver may include, for example, driving data (e.g., acceleration style, braking style, steering style, and so on). The data of the driver may also include in-cabin environmental data, such as preferred settings for lighting, temperature, preferred audio content, typical cabin context data (e.g., how often the driver drives with passengers, whether the passengers are children, head movement and/or eye gaze patterns detected via a dashboard cam, and the like. The data of the driver may be used to generate a model or profile of the driver, which may be used, for example, to personalize an intervention by an ADAS system of the vehicle 602, or to personalize an adjustment to in-cabin environmental controls based on driver behavior.

Vehicle control system 730 may include controls for controlling aspects of various vehicle systems 731 involved in different in-vehicle functions. These may include, for example, controlling aspects of vehicle audio system 732 for providing audio entertainment to the vehicle occupants, aspects of a climate control system 734 for meeting the cabin cooling or heating needs of the vehicle occupants, as well as aspects of a telecommunication system 736 for enabling vehicle occupants to establish telecommunication linkage with others.

Audio system 732 may include one or more acoustic reproduction devices including electromagnetic transducers such as one or more speakers 735. Vehicle audio system 732 may be passive or active such as by including a power amplifier. In some examples, in-vehicle computing system or infotainment system 609 may be the only audio source for the acoustic reproduction device or there may be other audio sources that are connected to the audio reproduction system (e.g., external devices such as a mobile phone). The connection of any such external devices to the audio reproduction device may be analog, digital, or any combination of analog and digital technologies.

Climate control system 734 may be configured to provide a comfortable environment within the cabin or passenger compartment of vehicle 602. Climate control system 734 includes components enabling controlled ventilation such as air vents, a heater, an air conditioner, an integrated heater and air-conditioner system, and so on. Other components linked to the heating and air-conditioning setup may include a windshield defrosting and defogging system capable of clearing the windshield and a ventilation-air filter for cleaning outside air that enters the passenger compartment through a fresh-air inlet.

Vehicle control system 730 may also include controls for adjusting the settings of various vehicle control elements 761 (or vehicle controls, or vehicle system control elements) related to the engine and/or auxiliary elements within a cabin of the vehicle, such as one or more steering wheel controls 762 (e.g., steering wheel-mounted audio system controls, cruise controls, windshield wiper controls, headlight controls, turn signal controls, and so on), instrument panel controls, microphone(s), accelerator/brake/clutch pedals, a gear shift, door/window controls positioned in a driver or passenger door, seat controls, cabin light controls, audio system controls, cabin temperature controls, and so on. Vehicle control elements 761 may also include internal engine and vehicle operation controls (e.g., engine controller module, actuator controls, valves, and so on) that are configured to receive instructions via the CAN bus of the vehicle to change operation of one or more of the engine, exhaust system, transmission, and/or other vehicle system. The control signals may also control audio output at one or more speakers 735 of the vehicle's audio system 732. For example, the control signals may adjust audio output characteristics such as volume, equalization, audio image (e.g., the configuration of the audio signals to produce audio output that appears to a user to originate from one or more defined locations), audio distribution among a plurality of speakers, and so on. Likewise, the control signals may control vents, air conditioner, and/or heater of climate control system 734. For example, the control signals may increase delivery of cooled air to a specific section of the cabin. For example, the control signals may increase delivery of cooled air to a specific section of the cabin. Additionally, while operating in an autonomous mode, the autonomous vehicle control system may control some or all of the above vehicle controls.

Vehicle controls 761 may include a steering control system 762, a braking control system 763, and an acceleration control system 764. Vehicle controls 761 may include additional control systems (such as trajectory planner 168 of FIG. 1 and/or trajectory planner 268 of FIG. 2). In some example, vehicle controls 761 may be operated autonomously, such as during autonomous vehicle operation. In other examples, vehicle controls 761 may be controlled by a user. Further, in some examples, a user may primarily control vehicle controls 761, while one or more ADAS 765 may intermittently adjust vehicle controls 761 in order to increase vehicle performance. For example, the one or more ADAS 765 may include a cruise control system, a lane departure warning system, a collision avoidance system, an adaptive braking system, and the like.

Steering control system 762 may be configured to control a direction of the vehicle. For example, during a non-autonomous mode of operation, steering control system 762 may be controlled by a steering wheel. For example, the user may turn the steering wheel in order to adjust a vehicle direction. During an autonomous mode of operation, steering control system 762 may be controlled by vehicle control system 730. In some examples, one or more ADAS 765 may adjust steering control system 762. For example, vehicle control system 730 may determine that a change in vehicle direction is requested, and may change the vehicle direction via controlling the steering control system 762. For example, vehicle control system 730 may adjust axles of the vehicle in order to change the vehicle direction.

Braking control system 763 may be configured to control an amount of braking force applied to the vehicle. For example, during a non-autonomous mode of operation, braking control system 763 may be controlled by a brake pedal. For example, the user may depress the brake pedal in order to increase an amount of braking applied to the vehicle. During an autonomous mode of operation, braking system 763 may be controlled autonomously. For example, vehicle control system 730 may determine that additional braking is requested, and may apply additional braking. In some examples, the autonomous vehicle control system may depress the brake pedal in order to apply braking (e.g., to decrease vehicle speed and/or bring the vehicle to a stop). In some examples, the one or more ADAS 765 may adjust braking control system 763.

Acceleration control system 764 may be configured to control an amount of acceleration applied to the vehicle. For example, during a non-autonomous mode of operation, acceleration control system 764 may be controlled by an acceleration pedal. For example, the user may depress the acceleration pedal in order to increase an amount of torque applied to wheels of the vehicle, causing the vehicle to accelerate in speed. During an autonomous mode of operation, acceleration control system 764 may be controlled by vehicle control system 730. In some examples, the one or more ADAS 765 may adjust acceleration control system 764. For example, vehicle control system 730 may determine that additional vehicle speed is requested, and may increase vehicle speed via acceleration. In some examples, vehicle control system 730 may depress the acceleration pedal in order to accelerate the vehicle. As an example of an ADAS 765 adjusting acceleration control system 764, the ADAS 765 may be a cruise control system, and may include adjusting vehicle acceleration in order to maintain a desired speed during vehicle operation.

Vehicle controls 761 may also include an ADAS controller 766, which may be used to configure and/or control the one or more ADAS 765. In various embodiments, the ADAS controller 766 may adjust the steering control 762, the braking control 763, the acceleration control 764 or other controls and/or actuator controls of vehicle 602 based on data inputs received, for example, from the sensor subsystem 710. For example, the ADAS controller 766 may command the ADAS 765 to adjust the braking control 763 based on a defined intervention strategy. The defined intervention strategy may rely on data inputs that include exterior cameras, proximity sensors, wheel speed sensors, route and/or traffic data (e.g., from navigation system 711), as well as in-cabin data such as facial expressions of one or more users (e.g., via an in-cabin camera 725) which may indicate drowsiness or stress, cabin temperature data, a volume of audio playback, and the like. Further, the ADAS controller 766 may be customizable for the vehicle or a user, with respect to a number or type of inputs, outputs, and other model parameters.

Vehicle controls 761 may also include a trajectory planner 768. In various embodiments, ADAS controller 766 may adjust one or more of vehicle controls 761 and/or other vehicle systems 731 in accordance with a planned trajectory of the vehicle generated by trajectory planner 768. The planned trajectory may be a trajectory from a first, current position of the vehicle to a second, desired position of the vehicle over a defined period of time.

Control elements positioned on an outside of a vehicle (e.g., controls for a security system) may also be connected to in-vehicle computing system or infotainment system 609, such as via inter-vehicle system communication module 722. The control elements of vehicle control system may be physically and permanently positioned on and/or in the vehicle for receiving user input. In addition to receiving control instructions from in-vehicle computing system or infotainment system 609, vehicle control system 730 may also receive input from one or more external devices 650 operated by the user, such as from mobile device 628. This allows aspects of vehicle systems 731 and vehicle control elements 761 to be controlled based on user input received from the external devices 650.

In-vehicle computing system or infotainment system 609 may further include one or more antennas 706. The in-vehicle computing system may obtain broadband wireless internet access via antennas 706, and may further receive broadcast signals such as radio, television, weather, traffic, and the like. The in-vehicle computing system or infotainment system 609 may receive positioning signals such as GPS signals via antennas 706. The in-vehicle computing system may also receive wireless commands via radio frequency (RF such as via antennas 706 or via infrared or other means through appropriate receiving devices. In some embodiments, antenna 706 may be included as part of audio system 732 or telecommunication system 736. Additionally, antenna 706 may provide AM/FM radio signals to external devices 650 (such as to mobile device 628) via external device interface 712.

One or more elements of the in-vehicle computing system or infotainment system 609 may be controlled by a user via user interface 718. User interface 718 may include a graphical user interface presented on a touch screen, such as touch screen 608 and/or display screen 611 of FIG. 6, and/or user-actuated buttons, switches, knobs, dials, sliders, etc. For example, user-actuated elements may include steering wheel controls, door and/or window controls, instrument panel controls, audio system settings, climate control system settings, and the like. A user may also interact with one or more applications of the in-vehicle computing system or infotainment system 609 and mobile device 628 via user interface 718. In addition to receiving a user's vehicle setting preferences on user interface 718, vehicle settings selected by in-vehicle control system may be displayed to a user on user interface 718. Notifications and other messages (e.g., received messages), as well as navigational assistance, may be displayed to the user on a display of the user interface. User preferences/information and/or responses to presented messages may be performed via user input to the user interface.

The in-vehicle computing system or infotainment system 609 may include a DMS 721. The DMS 721 may receive data from various sensors and/or systems of the vehicle (e.g., sensor subsystem 710, cameras 725, microphone 702) and may monitor aspects of driver behavior to improve a performance of the vehicle and/or a driving experience of the driver. In some examples, one or more outputs of the DMS 721 may be inputs into a driver model 723. In various embodiments, the driver model 723 may be used to estimate a cognitive state of the driver, and adjust one or more controls of vehicle control system 730 based on the estimated cognitive state of the driver.

Thus, an intervention strategy for an ADAS may be created that is customized for a driver and/or for passengers of a vehicle, where a personalized intervention of the ADAS may be based on the driving styles and cognitive states of the driver and/or the passengers. By providing customized ADAS interventions, a driving experience of the driver and/or passengers may be improved, and a level of satisfaction with the ADAS or a controller of an automated vehicle may be increased, leading to increased acceptance of and reliance on the ADAS and/or other automation systems. The intervention strategy and ADAS actuator adjustments may be performed by an ADAS controller based on flexible business logic that may be configurable, such that manufacturers can customize inputs and parameters of the ADAS controller to generate a personalized behavior of the ADAS controller.

The technical effect of providing ADAS interventions that are customized for one or more users of a vehicle is that a level of satisfaction with ADAS interventions may be increased, leading to wider adoption of ADAS technologies.

The disclosure also provides support for a method for controlling a vehicle, comprising: generating a driver profile of a driver of the vehicle, the driver profile including driving style data of the driver, estimating a cognitive state of the driver of the vehicle, and adjusting one or more actuator controls of an ADAS based on the estimated cognitive state of the driver, the driver profile of the driver, and route/traffic info of the vehicle. In a first example of the method, the driving style data includes at least: a braking style, an acceleration style, a steering style, and one or more preferred cruising speeds of the driver. In a second example of the method, optionally including the first example, estimating the cognitive state of the driver includes estimating one or more of the cognitive state of the driver and a physiological state of the driver, based on at least one of: an output of one or more in-cabin sensors, an output of a DMS of the vehicle, the output indicating at least one of: a level of drowsiness of the driver, a level of distraction of the driver, a cognitive load of the driver, and an estimated level of stress of the driver. In a third example of the method, optionally including one or both of the first and second examples, the one or more in-cabin sensors includes at least one of: an in-cabin camera of the vehicle, and a passenger seat sensor of the vehicle. In a fourth example of the method, optionally including one or more or each of the first through third examples, the driver profile is retrieved from a cloud-based server based on a driver ID. In a fifth example of the method, optionally including one or more or each of the first through fourth examples, the route/traffic info is retrieved from at least one of: a navigational system of the vehicle, and external sensors of the vehicle. In a sixth example of the method, optionally including one or more or each of the first through fifth examples, adjusting the one or more actuator controls of the ADAS further includes adjusting the one or more actuator controls of the ADAS based on: estimated cognitive states of one or more passengers of the vehicle, and driver profiles of the one or more passengers of the vehicle. In a seventh example of the method, optionally including one or more or each of the first through sixth examples, the vehicle is an autonomous vehicle and the driver is an operator of the autonomous vehicle. In an eighth example of the method, optionally including one or more or each of the first through seventh examples, adjusting one or more actuator controls of the ADAS based on the estimated cognitive state of the driver, the driver profile of the driver, and route/traffic info of the vehicle further includes inputting at least the estimated cognitive state, the driver profile, and the route/traffic info into an ADAS intervention model, and adjusting the one or more actuator controls based on an output of the ADAS intervention model, the ADAS intervention model including flexible logic configured within a pre-defined range of possible actuator control customizations. In a ninth example of the method, optionally including one or more or each of the first through eighth examples, the ADAS intervention model includes at least one of: a rules-based model, a statistical model, and a machine learning model.

The disclosure also provides support for a system of a vehicle, comprising: one or more processors having executable instructions stored in a non-transitory memory that, when executed, cause the one or more processors to: estimate a status of a user of the vehicle, the status based on a cognitive state of the user based on an output of at least one of: a DMS of the vehicle, and one or more in-cabin sensors of the vehicle, and adjust one or more actuator controls of an ADAS of the vehicle based on the cognitive state of the user, a driving style of the user, and route/traffic info of the vehicle. In a first example of the system, the user is one of a driver of the vehicle and a passenger of the vehicle. In a second example of the system, optionally including the first example, the vehicle is one of a taxi and an autonomous vehicle. In a third example of the system, optionally including one or both of the first and second examples, the one or more actuator controls of the ADAS include a steering wheel control, a brake control, and an accelerator control. In a fourth example of the system, optionally including one or more or each of the first through third examples, the estimated status includes a level of drowsiness of the user, a level of distraction of the user, a cognitive load of the user, and a level of stress of the user. In a fifth example of the system, optionally including one or more or each of the first through fourth examples, the driving style of the user includes at least one of: a braking style of the user, an acceleration style of the user, and a steering style of the user. In a sixth example of the system, optionally including one or more or each of the first through fifth examples, the driving style of the user is retrieved from a driver profile stored in a cloud-based driver profile database. In a seventh example of the system, optionally including one or more or each of the first through sixth examples, adjusting the one or more actuator controls of the ADAS based on the estimated status of the user, the driving style of the user, and route/traffic info of the vehicle further includes adjusting the one or more actuator controls of the ADAS of the vehicle based on an estimated aggregate status of a plurality of occupants of the vehicle, an aggregate driving style of the plurality of occupants, and route/traffic info of the vehicle.

The disclosure also provides support for a method, comprising: detecting whether a condition exists, where a driver of a vehicle has a driver status, the driver status including at least one of: an estimated high level of drowsiness, an estimated high level of distraction, an estimated high level of stress, and an estimated high cognitive load, in response to not detecting the condition, adjusting one or more actuator controls of an ADAS in a first manner, and in response to detecting the condition, adjusting the one or more actuator controls of the ADAS in a second manner, the second manner being different from the first manner, and the second manner being based on the driver status. In a first example of the method, the method further comprises: retrieving driving style data of the driver from a profile of the driver, and in response to detecting the condition, adjusting the one or more actuator controls of the ADAS in the second manner, the second manner being based on the driver status and the driving style data.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the embodiments described above with respect to FIGS. 1-5. The methods may be performed by executing stored instructions with one or more logic devices (e.g., processors) in combination with one or more hardware elements, such as storage devices, memory, hardware network interfaces/antennas, switches, clock circuits, and so on. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” “third,” and so on are used merely as labels, and are not intended to impose numerical requirements or a particular positional order on their objects. The following claims particularly point out subject matter from the above disclosure that is regarded as novel and non-obvious.

1. A method for controlling a vehicle, comprising:
generating a driver profile of a driver of the vehicle, the driver profile including driving style data of the driver;
estimating a cognitive state of the driver of the vehicle; and
adjusting one or more actuator controls of an advanced driver-assistance system (ADAS) based on the estimated cognitive state of the driver, the driver profile of the driver, and route/traffic info of the vehicle.

2. The method of claim 1, wherein the driving style data includes at least: a braking style; an acceleration style; a steering style; and one or more preferred cruising speeds of the driver.

3. The method of claim 1, wherein estimating the cognitive state of the driver includes estimating one or more of the cognitive state of the driver and a physiological state of the driver, based on at least one of:
an output of one or more in-cabin sensors;
an output of a driver monitoring system (DMS) of the vehicle, the output indicating at least one of:
a level of drowsiness of the driver;
a level of distraction of the driver;
a cognitive load of the driver; and
an estimated level of stress of the driver.

4. The method of claim 3, wherein the one or more in-cabin sensors includes at least one of: an in-cabin camera of the vehicle; and a passenger seat sensor of the vehicle.

5. The method of claim 1, wherein the driver profile is retrieved from a cloud-based server based on a driver ID.

6. The method of claim 1, wherein the route/traffic info is retrieved from at least one of: a navigational system of the vehicle; and external sensors of the vehicle.

7. The method of claim 1, wherein adjusting the one or more actuator controls of the ADAS further includes adjusting the one or more actuator controls of the ADAS based on:
estimated cognitive states of one or more passengers of the vehicle; and
driver profiles of the one or more passengers of the vehicle.

8. The method of claim 7, wherein the vehicle is an autonomous vehicle and the driver is an operator of the autonomous vehicle.

9. The method of claim 1, wherein adjusting one or more actuator controls of the ADAS based on the estimated cognitive state of the driver, the driver profile of the driver, and route/traffic info of the vehicle further includes inputting at least the estimated cognitive state, the driver profile, and the route/traffic info into an ADAS intervention model, and adjusting the one or more actuator controls based on an output of the ADAS intervention model, the ADAS intervention model including flexible logic configured within a pre-defined range of possible actuator control customizations.

10. The method of claim 9, wherein the ADAS intervention model includes at least one of:
a rules-based model;
a statistical model; and
a machine learning model.

11. A system of a vehicle, comprising:
one or more processors having executable instructions stored in a non-transitory memory that, when executed, cause the one or more processors to:
estimate a status of a user of the vehicle, the status based on a cognitive state of the user based on an output of at least one of:
a driver monitoring system (DMS) of the vehicle; and
one or more in-cabin sensors of the vehicle, and
adjust one or more actuator controls of an advanced driver-assistance system (ADAS) of the vehicle based on the cognitive state of the user, a driving style of the user, and route/traffic info of the vehicle.

12. The system of claim 11, wherein the user is one of a driver of the vehicle and a passenger of the vehicle.

13. The system of claim 12, wherein the vehicle is one of a taxi and an autonomous vehicle.

14. The system of claim 11, wherein the one or more actuator controls of the ADAS include a steering wheel control, a brake control, and an accelerator control.

15. The system of claim 11, wherein the estimated status includes a level of drowsiness of the user; a level of distraction of the user; a cognitive load of the user; and
a level of stress of the user.

16. The system of claim 11, wherein the driving style of the user includes at least one of:
a braking style of the user;
an acceleration style of the user; and
a steering style of the user.

17. The system of claim 11, wherein the driving style of the user is retrieved from a driver profile stored in a cloud-based driver profile database.

18. The system of claim 11, wherein adjusting the one or more actuator controls of the ADAS based on the estimated status of the user, the driving style of the user, and route/traffic info of the vehicle further includes adjusting the one or more actuator controls of the ADAS of the vehicle based on an estimated aggregate status of a plurality of occupants of the vehicle, an aggregate driving style of the plurality of occupants, and route/traffic info of the vehicle.

19. A method, comprising:
detecting whether a condition exists, where a driver of a vehicle has a driver status, the driver status including at least one of:
an estimated high level of drowsiness;
an estimated high level of distraction;
an estimated high level of stress; and
an estimated high cognitive load;
in response to not detecting the condition, adjusting one or more actuator controls of an advanced driver-assistance system (ADAS) in a first manner; and
in response to detecting the condition, adjusting the one or more actuator controls of the ADAS in a second manner, the second manner being different from the first manner, and the second manner being based on the driver status.

20. The method of claim 19, further comprising:
retrieving driving style data of the driver from a profile of the driver; and
in response to detecting the condition, adjusting the one or more actuator controls of the ADAS in the second manner, the second manner being based on the driver status and the driving style data.
